(19) United States
(12) Patent Application Publication
(10) Pub. No.: US 2004/0172637 A1
(43) Pub. Date: Sep. 2, 2004

(54) Code morphing manager

(75) Inventor: Oleg Koutyrine, Sandhausen (DE)

Correspondence Address: KENYON & KENYON, 1500 K STREET, N.W., SUITE 700, WASHINGTON, DC, 20005, US

(73) Assignee: SAP AG

(21) Appl. No.: 10/375,141

(22) Filed: Feb. 28, 2003

(51) Int. Cl. G06F 9/46; G06F 9/45; G06F 9/44

(52) U.S. Cl. 719/328; 717/136; 717/122

(57) ABSTRACT

Embodiments of the present invention provide a method and system for converting software from a source version to a target version. In one embodiment, a plurality of code morphers may be associated based on the input version and the output version of each code morpher. A sequerice of code morphers may be determined based on the source version and the target version, and then applied to the software. In another embodiment, a graph having a plurality of nodes and a plurality of edges between the nodes may be created. Each of the plurality of nodes may correspond to a version, while each of the plurality of edges may correspond to a code morpher. A path through the graph may be constructed from a source node, associated with the source version, to a target node associated with the target version. A sequence of code morphers may be determined from the path and then applied to the software. In a further embodiment, a finite state automata having a plurality of states and a plurality of transitions between the states may be created. Each of the plurality of states may correspond to a version, while each of the plurality of transitions may correspond to a code morpher. A path through the finite state automata may be constructed from a start state, associated with the source version, to an accept state associated with the target version. A sequence of code morphers may be determined from the path and then applied to the software.

### TECHNICAL FIELD

The present invention relates to software. More particularly, the present invention relates to transforming software applications using a sequence of code morphers.

### BACKGROUND OF THE INVENTION

Generally, a software application executes under the control of an operating system. The operating system typically includes an Application Programming Interface, or API, which defines the mechanisms by which the software application may access the services provided by the operating system, such as, for example, disk access, memory management, graphical user interface (GUI), etc. The execution environment may also include other components, in addition to the operating system, which may provide other services, such as, secure communications, database access and management, etc. Each of these components may also include an API that defines the mechanisms by which the software application may access the functionality of that particular component. Generally, the software application may be written to comply with a particular version of an API within the execution environment.

For enterprise business applications, such as, for example, order generation and sales activities, inventory management, etc., a suite of support services may be provided to facilitate data acquisition, transfer and management between a software application executing on a mobile computing device and a centrally-located enterprise system. In one example, a runtime component may offer various enterprise-related services to the mobile software application, accessed through the runtime component API. Unfortunately, improvements to the runtime component usually necessitate changes to the runtime component API, often resulting in different versions of the API which are not compatible with one another. In other words, software applications written to comply with an earlier version of an API may not comply with the latest version of the API included within the execution environment.

A code morpher is a program, or software component, that automatically transforms application code that is compliant with an earlier version of a particular API to application code that is compliant with a later version of the API. However, each code morpher typically supports only a single, atomic transformation from one specific API version (i.e., source version) to another specific API version (i.e., target version). Consequently, if a code morpher supporting the desired source-target API transformation is not available, the application code must be rewritten by hand to conform to the target version of the API.

### BRIEF DESCRIPTION OF THE DRAWINGS

FIG. 1 presents a diagram of an enterprise system architecture, according to an embodiment of the present invention.

FIG. 2 presents a detailed diagram illustrating mobile application development and runtime environments, according to an embodiment of the present invention.

FIG. 3 presents a code morphing graph, according to an embodiment of the present invention.

FIG. 4 presents a top level flow diagram illustrating a method for converting software from a source version to a target version, according to an embodiment of the present invention.

FIG. 5 presents a top level flow diagram illustrating a method for converting software from a source version to a target version, according to another embodiment of the present invention.

FIG. 6 presents a code morphing finite state automata, according to an embodiment of the present invention.

### DETAILED DESCRIPTION

Embodiments of the present invention provide a method and system for converting software from a source version to a target version. In one embodiment, a plurality of code morphers may be associated based on the input version and the output version of each code morpher. A sequence of code morphers may be determined based on the source version and the target version, and then applied to the software. In another embodiment, a graph having a plurality of nodes and a plurality of edges between the nodes may be created. Each of the plurality of nodes may correspond to a version, while each of the plurality of edges may correspond to a code morpher. A path through the graph may be constructed from a source node, associated with the source version, to a target node associated with the target version. A sequence of code morphers may be determined from the path and then applied to the software. In a further embodiment, a finite state automata having a plurality of states and a plurality of transitions between the states may be created. Each of the plurality of states may correspond to a version, while each of the plurality of transitions may correspond to a code morpher. A path through the finite state automata may be constructed from a start state, associated with the source version, to an accept state associated with the target version. A sequence of code morphers may be determined from the path and then applied to the software.

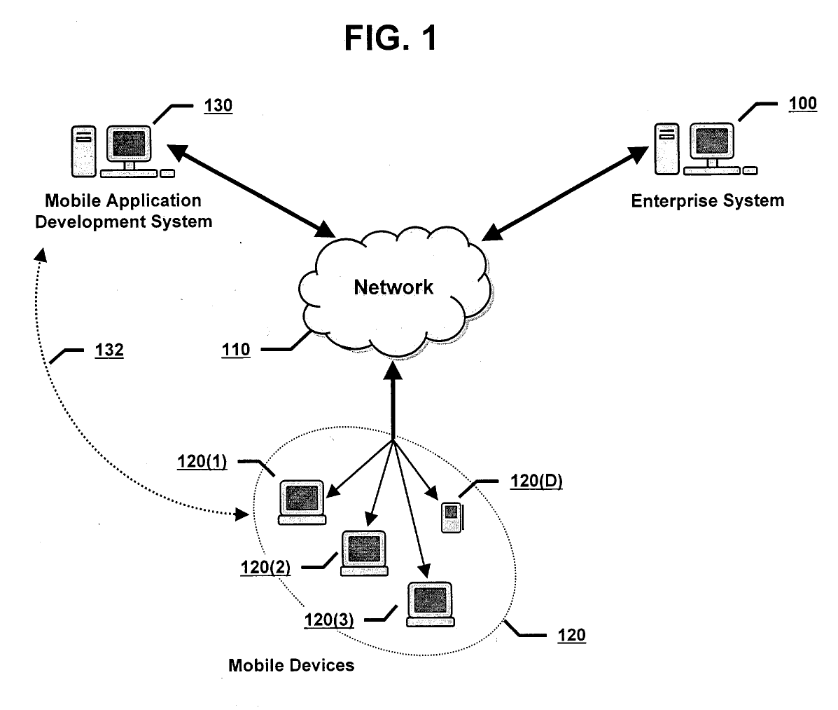

FIG. 1 presents a diagram of an enterprise system architecture, according to an embodiment of the present invention.

Enterprise system 100 may include at least one enterprise server having at least one consolidated database. Enterprise system 100 may support large scale system applications, involving perhaps hundreds, if not thousands, of local and remote users, or clients. Typically, enterprise system 100 manages many of the business processes and applications critical to the success of any particular company, including, for example, order generation and sales activities, inventory management, customer relations and support, product lifecycle management and human resources management, among others. The enterprise server may be a symmetric multiprocessing (SMP) computer, such as, for example, an IBM eServer™ zSeries™ 900, manufactured by International Business Machines Corporation of Armonk N.Y., a Sun Enterprise™ 10000 server, manufactured by Sun Microsystems of Santa Clara Calif., etc. The consolidated database may reside on one or more disks, or disk farms, coupled to the enterprise server, or, alternatively, directly to network 110. Enterprise system 100 may be coupled to network 110.

Network 110 may include any type or combination of public or private, wired or wireless networks including, for example, a local area network (LAN), a wide area network (WAN), a virtual private network (VPN), the Internet, etc. Various combinations and layers of network protocols may operate over network 110, including, for example, Ethernet (i.e., IEEE 802.3 CSMA/CD Ethernet), Wireless LAN (e.g., IEEE 802.11, IEEE 802.16, ETSI HYPERLAN/2, Bluetooth, General Packet Radio Service or GPRS, etc.), Transmission Control Protocol/Internet Protocol (TCP/IP), Asynchronous Transfer Mode (ATM), etc. Enterprise system 100 may communicate with plurality of mobile devices 120, i.e., mobile device 120(1), 120(2), 120(3). 120(D), via network 110. Various well-known authentication and data encryption techniques may be used to preserve an appropriate level of security in the public network context.

Plurality of mobile devices 120 may include, for example, notebook or laptop computers (e.g., IBM Thinkpad® T Series Notebook), pocket computers (e.g., HP iPAQ Pocket PC h5450s manufactured by Hewlett-Packard of Palo Alto Calif.), personal digital assistants or PDAs (e.g., Palm Tungsten™ T Handhelds manufactured by Palm, Inc. of Milpitas Calif.), smart cellular phones, etc. An operating system may also be provided for each mobile device, such as, for example, Palm OS 5, or any one of a number of Microsoft® Windows® operating systems manufactured by Microsoft Corporation of Redmond Wash., including, for example, Windows® 2000, Windows® XP, Windows® XP Embedded, Windows® CE NET, Windows® Pocket PC 2002, etc. Each of the plurality of mobile devices 120 may also include mobile application software. In an embodiment, mobile application software may include various functional layers, such as, for example, a user interface layer (UIL), a business object layer (BOL), a business document layer (BDL) or transaction layer (TL), etc.

In addition to the operating system, each of the plurality of mobile devices 120 may include other software components to support mobile application software, such as, for example, a browser (e.g., Microsoft® Internet Explorer, etc.), microbrowser or native user interface, a web server, a servlet engine, runtime interpreters, extended Markup Language (XML) parsers, data exchange interfaces (e.g., Simple Object Access Protocol, or SOAP, interface, etc.), authentication and encryption components, hardware device drivers, etc. In an embodiment, one, or more, of these runtime components may facilitate data acquisition, transfer and management between the mobile device and enterprise system 100. For example, a Runtime Framework (RF) may include several software components to provide various enterprise-related services to the mobile software application. These components may be accessed, for example, through an API associated with the Runtime Framework. In one embodiment, the Runtime Framework may have a single, associated API, while in another embodiment, the Runtime Framework may include multiple, distinct APIs. Different versions of the Runtime Framework, and associated APIs, may be developed and deployed onto plurality of mobile devices 120.

In one embodiment, the Runtime Framework may include various Java-based technologies, such as, for example, Java™ Virtual Machine (JVM), Java™ Server Pages (JSP), Java™ 2 Platform, Micro Edition (J2ME™), etc. In another embodiment, the Runtime Framework may include other mobile or embedded technologies, such as, for example, Microsoft® .NET technologies, Microsoft® eMbedded Visual Basic®, Microsoft® eMbedded Visual C++®, etc. Generally, mobile application software may be organized as runtime objects (ROs) representing executable code embodying various physical and logical constructs, such as, for example, data structures, function calls, procedures, object classes, etc. Executable code may reside on the mobile device in various forms, such as, for example, HTML files, Dynamic Link Libraries (DLLs), Visual Basic Application (VBA) files, etc. Each of the plurality of mobile devices 120 may include memory to store these runtime objects, as well as memory to store a local database, which may include data associated with the mobile application software.

Each of the plurality of mobile devices 120 may include a network interface to connect to network 110, such as, for example, a coaxial cable interface, a fiber-optic interface, a wireless network interface, etc. Plurality of mobile devices 120 may support an on-line operating mode when connected to network 110, and an off-line operating mode when not connected to network 110. Data integrity, consistency and security may be provided by a synchronization process. In one embodiment, the synchronization process may be included within the Runtime Framework, while in another embodiment, the synchronization process may be an additional component executing on each mobile device. For example, the synchronization process may include Sun JDBC™ technology and employ HyperText Transfer Protocol with Secure Sockets Layer (HTTPS) over the network interface.

Generally, enterprise business application functionality may be distributed between enterprise system 100 and plurality of mobile devices 120. Various data acquisition functions, such as, for example, order and invoice generation, service notification, etc., may be performed by mobile device 120(1), mobile device 120(2), etc., while other data management activities, such as product lifecycle management, may be performed by enterprise system 100. Mobile application development system 130 may be used to design and develop mobile application software for the plurality of mobile devices 120. For example, mobile application development system 130 may be a personal computer or workstation, such as, for example, an IBM IntelliStation® Z Pro, an HP Workstation zx6000, an etc.

Mobile application development system 130 may also include a scalable, high-performance operating system, such as, for example, Microsoft® Windows® XP Professional or 64-bit Edition operating systems, HP-UX (Unix) operating system, IBM AIX 5L (Unix) operating system, etc. A similar system may be used to design and develop related enterprise application software for enterprise system 100. In one embodiment, enterprise system 100 may include the appropriate components to design and develop enterprise application software, while in another embodiment, a separate development system may be used (i.e., an enterprise application development system similar to mobile application development system 130, for example). In a further embodiment, both mobile and enterprise application software may be designed on the same development system.

Mobile application development system 130 may include an application development environment (ADE), such as, for example, the SAP™ Mobile Application Studio (MAS) manufactured by SAP AG of Walldorf, Germany, to create, customize and enhance mobile application software for plurality of mobile devices 120. The ADE may include software components to access the various APIs associated with the mobile environment, including, for example, the API(s) associated with the Runtime Framework. In one embodiment, mobile application development system 130 may be coupled to network 110 and may include a network-based deployment component for installations, upgrades, and device configuration tasks associated with plurality of mobile devices 120. In another embodiment, mobile application development system 130 may communicate with each of the plurality of mobile devices 120 though direct connection 132, which may be, for example, an RS-232 (EIA-232) serial connection, an Ethernet connection, a wireless connection (RF or IR), etc. The ADE residing on mobile application development system 130 may also interact with various software components, objects, database(s), etc., residing on enterprise system 100.

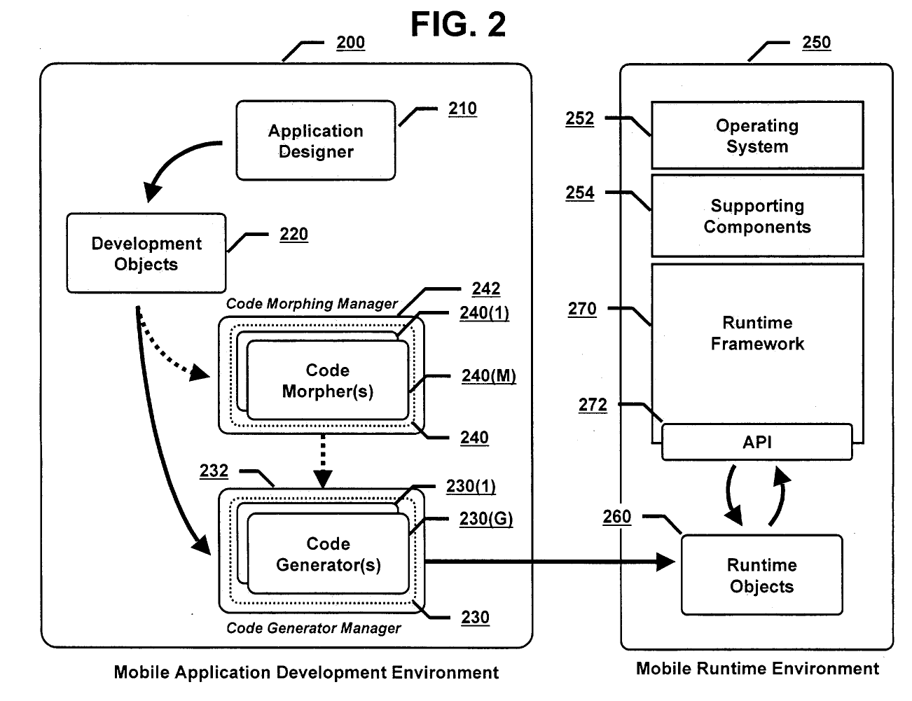

FIG. 2 presents a detailed diagram illustrating mobile application development and runtime environments, according to an embodiment of the present invention.

Mobile application development environment 200 may reside on mobile application development system 130, and may include several software components, such as, for example, application designer 210, plurality of code generators 230 (i.e., e.g., code generator 230(1) . . . 230(G)), and plurality of code morphers 240 (i.e., e.g., code morpher 240(1) . . . 240(M)). Mobile application development environment 200 may also include a code generator manager 232 to manage the plurality of code generators 230, as well as a code morphing manager 242 to manage the plurality of code morphers 240. In one embodiment, mobile application development environment 200 may be an integrated, visual environment to design, develop and prototype applications for the mobile environment, such as, for example, the SAP™ Mobile Application Studio.

Mobile runtime environment 250 may reside on a mobile device (e.g., mobile device 120(1), mobile device 120(2), etc.), and may include several software, firmware, etc. components, such as, for example, operating system 252, supporting components 254, Runtime Framework 270, Runtime Framework API 272, plurality of runtime objects 260, etc. Generally, software accessed through Runtime Framework API 272 may be included within Runtime Framework 270, while software accessed through different APIs may be included within supporting components 254. For example, in an embodiment, a web server may be included within supporting components 254, while in another embodiment, an XML parser may be included within Runtime Framework 270.

Application designer 210 may provide a graphical environment, or visual framework, in which to design mobile application software. For example, application designer 210 may create plurality of development objects 220, including, for example, declarative metadata, to represent user interface elements, data structures, program logic and data flow specifications, etc. In an embodiment, application designer 210 may arrange and manipulate user interface elements in the form of tiles, tilesets, etc. In another embodiment, application designer 210 may arrange and manipulate application information in the form of object-oriented data structures, or classes, such as, for example, Business Objects (BOs). Plurality of development objects 220 may be stored within a database residing on mobile application development system 130, such as, for example, an object-oriented Designtime Repository.

Generally, plurality of development objects 220 may define the behavior of the mobile software application independent of the particular architecture of the mobile runtime environment 250. In an embodiment, plurality of development objects 220 may include source code files (e.g., application class files, application project files, business component class files, business object class files, etc.), layout definition files (e.g., tile HTML files, etc.), configuration files (e.g., common registry files, machine-specific registry files, etc.), etc. In another embodiment, plurality of development objects 220 may be mapped to database elements within the mobile device's local database, as well as to database elements within the database, or databases, residing on enterprise system 100, using one or more Business Documents (BDocs). In a further embodiment, plurality of development objects 220 may access various elements within Runtime Framework 270 through a particular version of Runtime Framework API 272.

Each of the plurality of code generators 230 (i.e., e.g., code generator 230(1) . . . 230(G)) may transform plurality of development objects 220 into plurality of runtime objects 260 for a particular mobile runtime environment 250, such as, for example, one that includes Sun Java™ technology, one that includes Microsoft® .NET technology, etc. Based on the target mobile runtime environment 250, code generator manager 232 may invoke the appropriate code generator, selected from plurality of code generators 230, to transform plurality of development objects 220 into plurality of runtime objects 260. For example, a development object may be rendered into executable code. In one embodiment, each code generator may include a single target language model and render executable code directly. In another embodiment, the generation process may be divided into at least three phases, including, for example, consistency checking and realignment, syntax tree generation, and code rendering. In this embodiment, each code generator may be template-based, allowing code language to be moved into the template, thereby improving the readability and maintainability of the code generators, as well as facilitating the incorporation of new target code language models.

In an embodiment, the first phase may transform plurality of development objects 220 into an intermediate object model, repair inconsistencies, complete ‘incomplete’ definitions, and bridge semantic and structural differences between the designtime environment (e.g., mobile application development environment 200) and the runtime environment (e.g., mobile runtime environment 250). The second phase may transform the intermediate object model into an abstract syntax tree. In an embodiment, the syntax tree may obey a grammar, defined by at least one target language code template, and may include various entities, such as, for example, property declarations, initialization statements, methods, event handlers, control layout definitions, etc. The third phase may render the abstract syntax tree into executable code, represented by, for example, one or more runtime objects within plurality of runtime objects 260.

Alternatively, a development object may be transformed into a binary object rather than executable code. For example, the second phase of the generation process may create object structures rather than abstract syntax trees, and the third phase of the generation process may render, or persist, the object structures into binary objects. These binary objects may be represented by, for example, one or more runtime objects within plurality of runtime objects 260. In an embodiment, each of the plurality of development objects 220 (e.g., a Business Object and associated components, if any) may be transformed, individually, into runtime objects 260, and each generation phase may be invoked, sequentially, under the control of code generation manger 232.

Additionally, each of the plurality of code generators 230 may create runtime objects conforming to a particular version of an API, such as, for example, Version 1.0 of Runtime Framework API 272. Changes to Runtime Framework 270 may necessitate changes to Runtime Framework API 272, and may be denoted by an increase in version number (e.g., Version 1.0 to Version 2.0, Version 3.0 to Version 3.5, etc.). Accordingly, a new code generator, conforming to each new version of Runtime Framework API 272, may be needed to support the new versions. Similarly, new versions of application designer 210 may needed to create development objects conforming to new versions of Runtime Framework API 272. Alternatively, plurality of development objects 220, created by a current version of application designer 210, may be transformed, or morphed, to conform to new versions of Runtime Framework API 272. In one embodiment, a code morpher may transform plurality of development objects 220 during the generation of plurality of runtime objects 260, while in another embodiment, the code morpher may transform plurality of development objects 220 prior to the generation of plurality of runtime objects 260.

Generally, each of the plurality of code morphers 240 may transform plurality of development objects 220 from an input version, compliant with an earlier version of Runtime Framework API 272, to an output version, compliant with a later version of Runtime Framework API 272. Generally, each code morpher recognizes and corrects patterns of obsolete syntax between two specific versions of Runtime Framework API 272. For example, plurality of development objects 220 may include user interface objects (e.g., Tiles, etc.), business logic components (e.g., Business Objects, etc.), etc., that access components within Runtime Framework API 272 (e.g., Core Connectors, Business Anchors, etc.).

In one example, a Tile may be an object having a member, such as a Core Connector, referencing a Business Object. One version of Runtime Framework API 272 (e.g., Version 1.0) may support a Core Connector class, while another version of Runtime Framework API 272 (e.g., Version 2.0) may support a Business Anchor class. In an embodiment, code morpher 240(1) may transform plurality of development objects 220 from Runtime Framework API 272 Version 1.0 to Version 2.0. In this embodiment, code morpher 240(1) may process each of the plurality of development objects 220, recognize instances of “Core Connector” declarations (compliant with Version 1.0), and replace each instance with a “Business Anchor” declaration (compliant with Version 2.0).

In another example, a Business Anchor may be an object having a name (e.g., ANCHOR_NAME) by which the Business Anchor may be referenced. Depending upon the specific implementation of the object class, the Business Anchor may be accessed using either a public data member (or method), or a private data member (or method). One version of Runtime Framework API 272 (e.g., Version 2.0) may allow access to a public property of the Business Anchor, such as, for example, public{ANCHOR_NAME}, etc., while another version of Runtime Framework API 272 (e.g., Version 3.0) may allow access to only a private property of the Business Anchor, such as, for example, private{ANCHOR_NAME}, getAnchorByName(“ANCHOR_NAME”), etc. In an embodiment, code morpher 240(2) may transform plurality of development objects 220 from Runtime Framework API 272 Version 2.0 to Version 3.0. In this embodiment, code morpher 240(2) may process each of the plurality of development objects 220, recognize instances of “public{ANCHOR_NAME}” (compliant with Version 2.0), and replace each instance with “private{ANCHOR_NAME}” (compliant with Version 3.0).

Based on the target mobile runtime environment 250, the appropriate code morpher may be selected from plurality of code morphers 240 to transform plurality of development objects 220 from a source version to a target version of Runtime Framework API 272. Generally, each of the plurality of code morphers 240 may transform development objects from an input version and to an output version of Runtime Framework API 272. As versions of Runtime Framework API 272 proliferate, more than one code morpher may need to be invoked to transform plurality of development objects 220 from a source version, to an intermediate version, or versions, to a final, target version of Runtime Framework API 272. For complicated code morphing sequences, the developer may need to invoke multiple code morphers, in the correct sequence, to complete the transformation. Advantageously, code morphing manager 242 may remove the developer from the selection of the appropriate code morpher(s), thereby improving the process of morphing application code from one Runtime Framework API version to another Runtime Framework API version.

In an embodiment, code morpher 240(1) may transform development objects from Version 1.0 to Version 2.0, code morpher 240(2) may transform development objects from Version 2.0 to Version 3.0, code morpher 240(3) may transform development objects from Version 3.0 to Version 3.5, code morpher 240(4) may transform development objects from Version 3.0 to Version 4.0, etc. However, in this embodiment, there may not be a specific code morpher, within plurality of code morphers 240, to transform development objects from Version 1.0 directly to Version 3.0. Consequently, code morpher 240(1) may be invoked first, transforming plurality of development objects 220 from Version 1.0 to Version 2.0, and code morpher 240(2) may be invoked second, transforming plurality of development objects 220 from Version 2.0 to Version 3.0. In this manner, plurality of development objects 220 may be transformed from a source version of Runtime Framework API 272 (i.e., Version 1.0) to a target version of Runtime Framework API 272 (i.e., Version 3.0). In this embodiment, code morpher 240(1) may have an input version number of “1.0” and an output version number of “2.0,” while code morpher 240(2) may have an input version number of “2.0” and an output version number of “3.0.” Thus, the source version equals the input version of the first code morpher (e.g., 1.0) the output version of the first code morpher equals the input version of the second code morpher (e.g., 2.0), and the output version of the last code morpher equals the target version (e.g., 3.0).

Code morphing manager 242 may group, associate, chain, index, etc., plurality of code morphers 240 together to create various sequences based on their respective input and output version numbers. For example, code morphing manager 242 may transform plurality of development objects 220, from a source version to a target version, by selecting the appropriate code morpher group. In an embodiment, a first group may consist of code morpher 240(1) and may transform plurality of development objects 220 from Version 1.0 (i.e., source version) to Version 2.0 (i.e., target version). A second group may consist of code morphers 240(1) and 240(2) and may transform plurality of development objects 220 from Version 1.0 (i.e., source version) to Version 3.0 (i.e., target version). Each of the plurality of code morphers 240 may be assigned to one or more groups, such as code morpher 240(1) in this example. In another embodiment, code morphing manager 242 may create a graph having a plurality of nodes, representing version numbers, and a plurality of edges connecting the various nodes, representing code morphers.

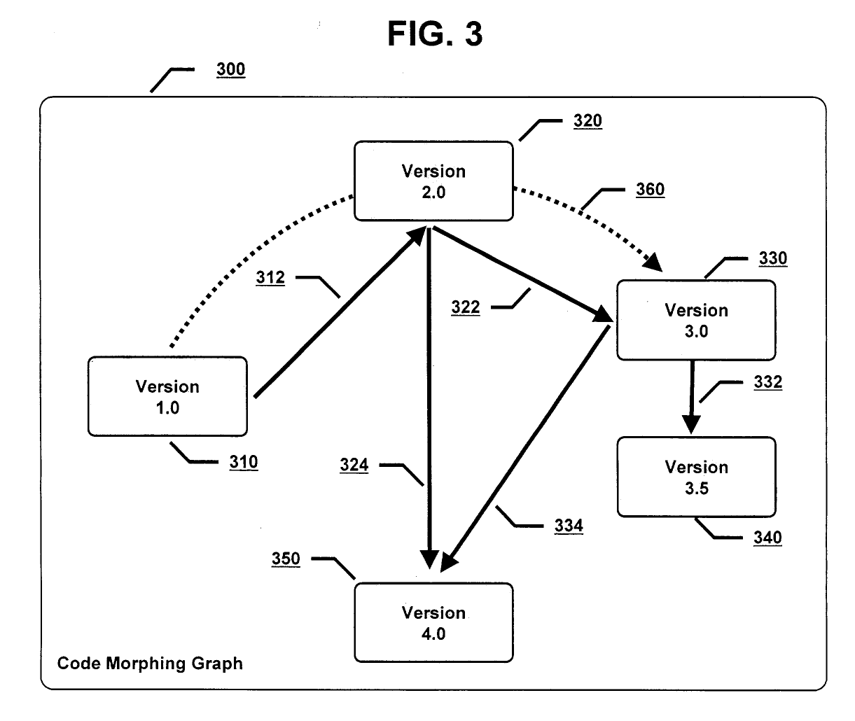

FIG. 3 presents a code morphing graph, according to an embodiment of the present invention.

In an embodiment, graph 300 may include a plurality of nodes (e.g., node 310, node 320, node 330, node 340, etc.), each corresponding to a version, and a plurality of edges (e.g., edge 312, edge 322, edge 324, edge 332, edge 334, etc.), each corresponding to one of the plurality of code morphers 240. As discussed above, each of the plurality of code morphers 240 may transform software from one version of an API (i.e., input version) to another version of the API (i.e., output version). In one embodiment, code morphing manager 242 may construct a path through graph 300 from a source version to a target version, such as, for example, path 360 from node 310 (Version 1.0) to node 330 (Version 3.0). Code morphing manager 242 may determine that path 360 includes edge 312 and edge 322. In an embodiment, edge 312 may correspond to code morpher 240(1) and edge 322 may correspond to code morpher 240(2). Code morphing manager 242 may then invoke each of these code morphers, in the proper sequence, to transform plurality of development objects from a source version of the API (e.g., Version 1.0) to a target version of the API (e.g., Version 3.0), such as, for example, Runtime Framework API 272.

Multiple paths through graph 300 may created between any two arbitrary nodes, and code morphing manager 242 may select a preferred path based on various criteria, such as, for example, a first path, a shortest path, a path including a minimum set of edges, a path containing only major version numbers (e.g., 1.0, 2.0, 3.0, etc.), an optimum path, etc. Various methods may be used to determine the different paths through graph 300, such as, for example, Dijkstra's algorithm, Johnson's algorithm, etc. For example, two paths (not shown for clarity) may be constructed between node 310 and node 350, the first path may include edge 312, node 320 and edge 324, while the second path may include edge 312, node 320, edge 322, node 330 and edge 334. New nodes may be added to graph 300, and new code morphers may be developed, added to plurality of code morphers 240 and incorporated into graph 300 as new edges between nodes. In this manner, code morphing manager 242 may determine a path through graph 300, based on the source version and the target version, and apply the appropriate code morpher(s) from plurality of code morphers 240 in their proper sequence.

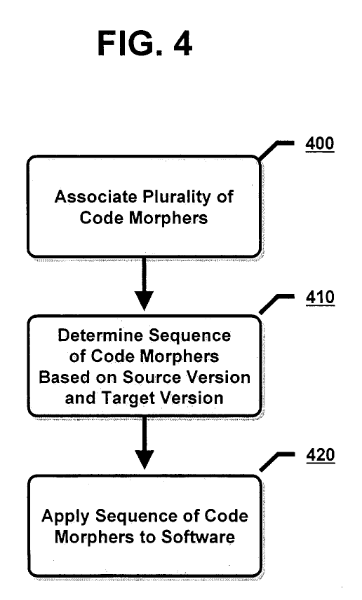

FIG. 4 presents a top level flow diagram illustrating a method for converting software from a source version to a target version, according to an embodiment of the present invention.

A plurality of code morphers may be associated (400) based on the input version and output version of each code morpher. In an embodiment, code morphing manager 242 may associate (400) plurality of code morphers 240 based on the input and output versions of each code morpher. For example, one association, group, sequence, etc., of code morphers may include code morpher 240(1), having an input version equal to Version 1.0 and an output version equal to Version 2.0, and code morpher 240(2), having an input version equal to Version 2.0 and an output version equal to Version 3.0. In this embodiment, the input and output versions of each code morpher may correspond to a particular version of an API, such as, for example, Runtime Framework API 272. Generally, the input and output versions of the plurality of code morphers 240 may correspond to particular versions of any API residing within mobile runtime environment 250. In one embodiment, plurality of code morphers 240 may correspond to the same API (e.g., Runtime Framework API 272), while in another embodiment, plurality of code morphers 240 may include different APIs.

A sequence of code morphers may be determined (410) based on the source version and target version of the software. In an embodiment, code morphing manager 242 may determine (410) a sequence of associated code morphers based on a source version and a target version of the mobile application software, such as, for example, plurality of development objects 220. In this example, plurality of development objects 220 may be created by application designer 210 in accordance with a particular version of the API (i.e., the source version), such as Runtime Framework API 272 Version 1.0. The developer may desire to transform plurality of development objects 220 to a different version of the API (i.e., the target version), such as Runtime Framework API 272 Version 3.0. Based on the source version and the target version, code morphing manager 242 may determine (410) which sequence of code morphers may be invoked to transform plurality of development objects 220.

The sequence of code morphers may be applied (420) to the software. In an embodiment, code morphing manager 242 may apply (420) each code morpher within a particular sequence to the mobile application software. Each code morpher within the sequence may transform plurality of development objects 220 from an input version to an output version, so that the sequential application of the code morphers results in an overall transformation from a source version to a target version. For example, code morphing manager 242 may apply (420) a particular sequence by invoking code morpher 240(1), to transform plurality of development objects 220 from Version 1.0 to Version 2.0, and then code morpher 240(2), to transform plurality of development objects 220 from Version 2.0 to Version 3.0. The application of this sequence results in an overall transformation of plurality of development objects 220 from Version 1.0 to Version 3.0.

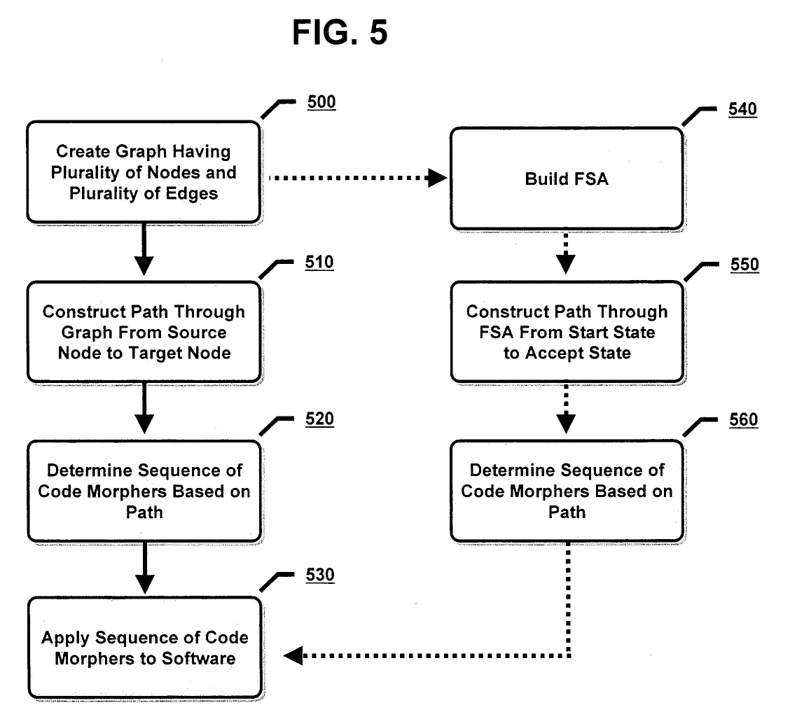

FIG. 5 presents a top level flow diagram illustrating a method for converting software from a source version to a target version, according to another embodiment of the present invention.

A graph having a plurality of nodes and a plurality of edges may be created (500). In one embodiment, the graph may be created (500) manually by a developer, etc., while in another embodiment, the graph may be created (500) by a software component within mobile application development environment 200, such as code morphing manager 242, etc. For example, graph 300 may include nodes corresponding to different API versions (e.g., node 310, etc.), and edges corresponding to code morphers (e.g., edge 312, etc.), as discussed above with reference to FIG. 3. The API may be, for example, Runtime Framework API 272, an API corresponding to one of the supporting components 254, an API corresponding to operating system 252, etc.

A path may be constructed (510) through the graph from a source node to a target node. In an embodiment, code morphing manager 242 may construct (510) a path through graph 300 based on a source node associated with an source version, and a target node associated with an target version. In an example, plurality of development objects 220 may be created by application designer 210 in accordance with a source version, such as Runtime Framework API 272 Version 1.0. The developer may desire to transform plurality of development objects 220 to a target version, such as Runtime Framework API 272 Version 3.0. Based on the source and target versions, code morphing manager 242 may construct (510) path 360 through graph 300 using any number of methods, including, for example, a first path, a shortest path, etc. In this example, path 360 may be constructed (510) from source node 310 (Version 1.0) to target node 330 (Version 3.0) via edge 312, node 320 (Version 2.0), and edge 322.

A sequence of code morphers may be determined (520) based on the path. In an embodiment, a path through graph 300 may include at least two nodes and at least one edge corresponding to a particular code morpher(s). For example, path 360 may include three nodes and two edges, i.e., nodes 310, 320 and 330, corresponding to Versions 1.0, 2.0 and 3.0, respectively, and edge 312 and edge 322, corresponding to code morpher 240(1) and code morpher 240(2), respectively. Code morphing manager 242 may determine (520) the sequence of code morphers based on the sequence of edges contained within path 360, i.e., code morpher 240(1) and code morpher 240(2).

The sequence of code morphers may be applied (530) to the software. In an embodiment, code morphing manager 242 may apply (530) each code morpher within the sequence to the mobile application software. For example, each code morpher within the sequence may transform plurality of development objects 220 from an input version to an output version, so that the sequential application of the code morphers results in an overall transformation from a source version to a target version. For example, code morphing manager 242 may apply (530) the sequence determined from path 360 by invoking code morpher 240(1), to transform plurality of development objects 220 from Version 1.0 to Version 2.0, and then code morpher 240(2), to transform plurality of development objects 220 from Version 2.0 to Version 3.0. The application of this sequence results in an overall transformation of plurality of development objects 220 from Version 1.0 to Version 3.0.

In another embodiment, code morpher manager may build (540) a finite state automata (FSA) based on the graph. In this embodiment, the FSA may include a set of states, corresponding to the nodes of the graph (e.g., versions), and a set of transitions, corresponding to the edges of the graph (e.g., code morphers). Advantageously, the declarative structure of the graph may be mapped to the executable structure of the FSA. For example, graph 300 may be represented by an FSA including a set of states corresponding to nodes 310, 320, 330, 340 and 350, and a set of transitions corresponding to edges 312, 322, 324, 332 and 334.

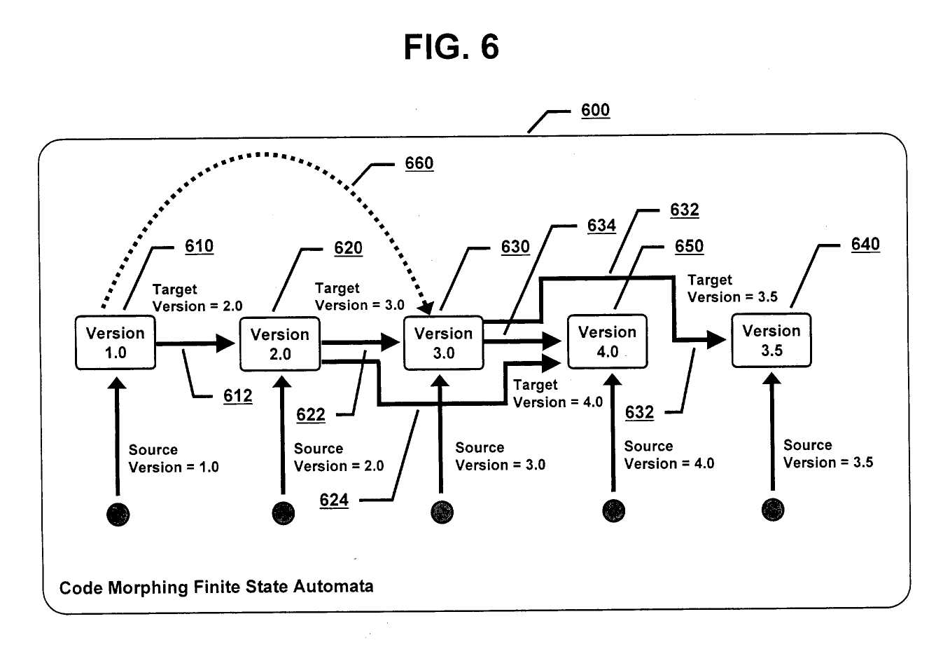

FIG. 6 presents a code morphing finite state automata, according to an embodiment of the present invention.

In an embodiment, code morpher finite state automata 600, or FSA 600, may include a plurality of states (e.g., state 610, state 620, state 630, state 640, state 650, etc.), each corresponding to a version, and a plurality of transitions (e.g., transition 612, transition 622, transition 624, transition 632, transition 634, etc.), each corresponding to one of the plurality of code morphers 240. As discussed above, each of the plurality of code morphers 240 may transform software from one version of an API (i.e., input version) to another version of the API (i.e., output version). In one embodiment, FSA 600 may be implemented as one or more object oriented libraries, classes, etc., and integrated into mobile application development environment 200.

Referring to FIGS. 5 and 6, a path may be constructed (550) through the FSA from a start state to an accept state. In an embodiment, code morphing manager 242 may construct (550) a path through FSA 600 based on a start state associated with a source version, and an accept state associated with a target version. In an example, plurality of development objects 220 may be created by application designer 210 in accordance with a source version, such as Runtime Framework API 272 Version 1.0. The developer may desire to transform plurality of development objects 220 to a target version, such as Runtime Framework API 272 Version 3.0. Based on the source and target versions, code morphing manager 242 may construct (550) path 660 through FSA 600 using any number of methods, including, for example, a first path, a shortest path, etc. Path 660 may include a start state, i.e., state 610 and an accept state, i.e., state 630, corresponding to Versions 1.0 and 3.0, respectively. An intermediate state, i.e., state 620 corresponding to Version 2.0, may also be included in path 660.

A sequence of code morphers may be determined (560) based on the path through the FSA. In an embodiment, a path through the FSA may include at least two states, corresponding to the start state and the accept state, and at least one transition, corresponding to a particular code morpher(s). For example, path 660 may include three states and two transitions, i.e., states 610, 620 and 630, corresponding to Versions 1.0, 2.0 and 3.0, respectively, and transitions 612 and 622, corresponding to code morphers 240(1) and 240(2), respectively. Code morphing manager 242 may determine (560) the sequence of code morphers based on the sequence of transitions contained within path 660, i.e., code morpher 240(1) and code morpher 240(2).

The sequence of code morphers may then be applied (530) to the software, as discussed above and with respect to FSA 600, path 660, etc.

Several embodiments of the present invention are specifically illustrated and described herein. However, it will be appreciated that modifications and variations of the present invention are covered by the above teachings and within the purview of the appended claims without departing from the spirit and intended scope of the invention.

What is claimed is:

1. A method for converting software from a source version to a target version, comprising:
creating a graph having a plurality of nodes and a plurality of edges, each of the plurality of nodes corresponding to a version and each of the plurality of edges corresponding to a code morpher having an input version and an output version;
constructing a path from a source node, associated with the source version, to a target node associated with the target version;
determining a sequence of code morphers based on the path; and
applying the sequence of code morphers to the software.

2. The method of claim 1, wherein the path comprises a shortest path between the source node and the target node.

3. The method of claim 1, wherein the path comprises an optimum path between the source node and the target node.

4. The method of claim 1, wherein the input version of a first code morpher in the sequence equals the source version, and the output version of a last code morpher in the sequence equals the target version.

5. The method of claim 4, wherein the input version of each code morpher after the first code morpher in the sequence is equal to the output version of an immediately preceding code morpher in the sequence.

6. The method of claim 5, wherein the output version of each code morpher before the last code morpher in the sequence is equal to the input version of an immediately succeeding code morpher in the sequence.

7. The method of claim 1, wherein the software includes a plurality of elements associated with a runtime framework.

8. The method of claim 7, wherein:
the source version is associated with a first runtime framework version; and
the target version is associated with a second runtime framework version.

9. The method of claim 8, wherein said applying the sequence of code morphers comprises:
for each code morpher in the sequence of code morphers:
identifying at least one of the plurality of elements; and
converting each of the identified elements from the input version to the output version.

10. The method of claim 9, wherein the plurality of elements include variables.

11. The method of claim 9, wherein the plurality of elements include data structures.

12. The method of claim 9, wherein the plurality of elements include classes.

13. The method of claim 9, wherein the plurality of elements include functions.

14. A computer readable medium including instructions adapted to be executed by at least one processor to implement a method for transforming software from a source version to a target version, the method comprising:
creating a graph having a plurality of nodes and a plurality of edges, each of the plurality of nodes corresponding to a version and each of the plurality of edges corresponding to a code morpher having an input version and an output version;
constructing a path from a source node, associated with the source version, to a target node associated with the target version;
determining a sequence of code morphers based on the path; and
applying the sequence of code morphers to the software.

15. The computer readable medium of claim 14, wherein the path comprises at least one of a shortest path and an optimum path.

16. The computer readable medium of claim 14, wherein the input version of a first code morpher in the sequence equals the source version, and the output version of a last code morpher in the sequence equals the target version.

17. The computer readable medium of claim 16, wherein the input version of each code morpher after the first code morpher in the sequence is equal to the output version of an immediately preceding code morpher in the sequence.

18. The computer readable medium of claim 17, wherein the output version of each code morpher before the last code morpher in the sequence is equal to the input version of an immediately succeeding code morpher in the sequence.

19. The computer readable medium of claim 14, wherein the software includes a plurality of elements associated with a runtime framework.

20. The computer readable medium of claim 19, wherein:
the source version is associated with a first runtime framework version; and
the target version is associated with a second runtime framework version.

21. The computer readable medium of claim 20, wherein said applying the sequence of code morphers comprises:
for each code morpher in the sequence of code morphers:
identifying at least one of the plurality of elements; and
converting each of the identified elements from the input version to the output version.

22. The computer readable medium of claim 21, wherein the plurality of elements include at least one of variables, data structures, classes and functions.

23. A system for transforming application software from an application programming interface source version to an application programming interface target version, comprising:
a processor; and
a memory, coupled to the processor, storing the application software and instructions adapted to be executed by the processor to:
create a graph having a plurality of nodes and a plurality of edges, each of the plurality of nodes corresponding to a version and each of the plurality of edges corresponding to a code morpher having an input version and an output version,
construct a path from a source node associated with the source version, to a target node associated with the target version,
determine a sequence of code morphers based on the path, and
apply the sequence of code morphers to the software.

24. The system of claim 23, wherein the path comprises at least one of a shortest path and an optimum path.

25. The system of claim 23, wherein the input version of a first code morpher in the sequence equals the source version, and the output version of a last code morpher in the sequence equals the target version.

26. The system of claim 25, wherein the input version of each code morpher after the first code morpher in the sequence is equal to the output version of an immediately preceding code morpher in the sequence.

27. The system of claim 26, wherein the output version of each code morpher before the last code morpher in the sequence is equal to the input version of an immediately succeeding code morpher in the sequence.

28. The system of claim 24, wherein the software includes a plurality of elements associated with a runtime framework.

29. The system of claim 28, wherein:
the source version is associated with a first runtime framework version; and
the target version is associated with a second runtime framework version.

30. The system of claim 29, wherein said apply the sequence of code morphers comprises:
for each code morpher in the sequence of code morphers:
identify at least one of the plurality of elements; and
convert each of the identified elements from the input version to the output version.

31. The system of claim 30 wherein the plurality of elements include at least one of variables, data structures, classes and functions.

32. A method for converting software from a source version to a target version, comprising:
associating a plurality of code morphers based on an input version and an output version of each code morpher;
determining a sequence of code morphers based on the source version and the target version; and
applying the sequence of code morphers to the software.

33. The method of claim 32, wherein the input version of a first code morpher in the sequence equals the source version, and the output version of a last code morpher in the sequence equals the target version.

34. The method of claim 33, wherein the input version of each code morpher after the first code morpher in the sequence is equal to the output version of an immediately preceding code morpher in the sequence.

35. The method of claim 34, wherein the output version of each code morpher before the last code morpher in the sequence is equal to the input version of an immediately succeeding code morpher in the sequence.

36. The method of claim 35, wherein the software includes a plurality of elements associated with at least one runtime framework.

37. A method for converting software from a source version to a target version, comprising:
creating a finite state automata having a plurality of states and a plurality of transitions, each of the plurality of states corresponding to a version and each of the plurality of transitions corresponding to a code morpher having an input version and an output version;
constructing a path from a start state, associated with the source version, to an accept state, associated with the target version;
determining a sequence of code morphers based on the path; and
applying the sequence of code morphers to the software.

38. The method of claim 37, wherein the path comprises a shortest path between the start state and the accept state.

39. The method of claim 37, wherein the path comprises an optimum path between the start state and the accept state.

40. The method of claim 37, wherein the software includes a plurality of elements associated with a runtime framework.

41. The method of claim 40, wherein:
the source version is associated with a first runtime framework version; and
the target version is associated with a second runtime framework version.

42. The method of claim 41, wherein said applying the sequence of code morphers comprises:
for each code morpher in the sequence of code morphers:
identifying at least one of the plurality of elements; and
converting each of the identified elements from the input version to the output version.
